(19) United States
(12) Patent Application Publication
(10) Pub. No.: US 2009/0327528 A1
(43) Pub. Date: Dec. 31, 2009

(54) DATA STORAGE METHOD WITH MULTIPLE PROTOCOLS FOR PRELOADING DATA

(75) Inventor: Eitan MARDIKS, Ra'anana (IL)

Correspondence Address: BRINKS HOFER GILSON & LIONE/SanDisk, P.O. BOX 10395, CHICAGO, IL, 60610, US

(73) Assignee: SanDisk IL Ltd., Kfar Saba (IL)

(21) Appl. No.: 12/145,556

(22) Filed: Jun. 25, 2008

(51) Int. Cl. G06F 3/00

(52) U.S. Cl. 710/11; 710/14

(57) ABSTRACT

A method uses multiple communication modes for fast uploading of a datum preloaded from a manufacturing device to a data storage device over existing external contacts of the data storage device. Preferentially the data storage device is a high capacity SIM card and a user mode allows communication by standard protocols such as ISO, SD/MMC and USB whereas a manufacturer mode applies a multi data line SD/MMC protocol or a custom protocol for high speed data uploading.

This application is related to U.S. patent application Ser. No. ______ of the same inventor, which is entitled “DATA STORAGE DEVICE WITH MULTIPLE PROTOCOLS FOR PRELOADING DATA” and filed on the same day as the present application. The application, is incorporated in its entirety as if fully set forth herein.

### FIELD AND BACKGROUND OF THE INVENTION

Various methods and systems to preload data on a data storage device are possible, and particularly, methods and systems may allow a manufacturer to produce a device (for example a smart card) and load data (for example identification information) before distribution to the consumer.

Flash memory devices and particularly smart cards are very well known in the art of computer engineering. A smart card contains a secure microprocessor in a credit card sized package. Smart cards are designed to comply with published standards so that applications and card reader devices can be designed independently of the card. Particularly, many smart cards are designed to comply with the ISO/IEC 7816 series of standards that define the physical shape of the smart card, the communications protocols and the positions and shapes of the electrical contacts for each protocol, the electrical power supplied to the card and the position of the electrical contacts to which the power is supplied, and the functionality and the format of the commands sent to the card and the response returned by the card.

Smart cards are often used for the purpose of user identification. The user identification may be performed using personal information (for example an Electronic Passport or a pass card for an electronic gate may store personalized biometric data describing fingerprints or iris or facial pictures to positively identify a user to a security agent or an electronic lock) or non-personal information (for example a Subscriber Identity Module (SIM) card identifies a subscriber of a cellular phone network). Smart cards also serve to track financial information, for example a smart credit/debit card stores a user's credit information and tracks purchases making it possible for a merchant to approve a sale without contacting the credit provider. Similarly a smart phone card may track prepaid telephone calls and remaining credit for a user. Smart cards are also used for encryption and decryption of signals; such a smart card may serve as a key allowing a user to receive privileged communications or to unlock functionality of proprietary software from a network.

Generally, smart cards also contain program memory for applications. These preloaded programs are generally stored in Read Only Memory (ROM—for example mask programmable ROM or EPROM or NOR-type flash memory) that is not accessible to a user of the card. Many ROM technologies involve time-consuming physical modifications to program or reprogram the card.

A SIM card generally belongs to a service provider of a cellular network. The service provider supplies the card to a subscriber of the network who is the end user of the SIM card. The card then identifies the subscriber's communication device to the network. Based on this identification the service provider supplies network services and bills the user.

Typically manufacturing of a SIM card includes two major steps: A) fabrication of the card and B) customization of the card per the MNO (MNO=Mobile Network Operator) specifications. Fabrication of the card includes constructing the physical card (e.g. processor, memory, connectors) and programming the card with a basic operating mode (for example one or more data transfer protocols and other basic functions that are sometimes referred to in as Basic Input/Output Systems BIOS). Generally an operating mode of the card is according to a published standard, for example ISO 7816. In the case of a modern high capacity SIM card, the customization may also involve two steps: 1) customization of the SIM part of the card and 2) uploading data to the mass storage area of the card. A single manufacturer may carry out all of the manufacturing steps. It is also possible to divide the manufacturing between a card producer, which fabricates the card and customizes the SIM part of the card, and one or more agents of the MNO, which upload (preload) data to the card before distribution of the card to a user.

Personal, data and network security are ever becoming more important and more sophisticated. Furthermore, user devices are ever becoming more flexible. A SIM card that was once a component of a simple cellular telephone may now be placed in a sophisticated mobile computer having one of various available operating systems. There has developed a market for smart cards that store data and programs and particularly for smart cards that include more memory than heretofore possible (for example cards of more than 500 Kbytes are currently planned or available). Particularly as standards change and new devices are developed there is a need that this data should be available for modification by the user.

There is thus a widely recognized need for, and it would be highly advantageous to have a smart card/data storage device that can be economically programmed by a manufacturer with a large amount of data that is customizable for particular card distributor MNO or a particular population of users and is accessible for modification by the user.

### SUMMARY OF THE INVENTION

Various methods to preload data to a data storage device are provided herein, and particularly, methods may employ a high speed data transfer protocol in a manufacturing mode, which can increase production efficiency by speeding preloading of data to a device.

An embodiment of a method of customizing a data storage device having N externally accessible electrical contacts may include the step of providing a user mode. The user mode may include a first protocol employing a first subset containing K elements (each element being one of the N externally accessible electrical contacts) for transferring data between the data storage device and a host. The embodiment of a method may also contain the step of initiating the data storage device to operate in a manufacturing mode having a second protocol employing a second subset containing M of the N externally accessible electrical contacts. The second subset may contain at least one common element contained in both the first subset and the second subset. The said second subset may also contain at least one exclusive element not contained in the first subset. The method may also include uploading of a datum by a manufacturer to the data storage device via the manufacturer mode

An embodiment of a method for customizing a data storage device may further include the step of disabling the manufacturer mode after uploading the preloaded data.

In an embodiment of a method for customizing a data storage device, the manufacturing mode may be made inaccessible to an end user. For example, use of the manufacturer mode could be blocked to anyone except an authorized manufacturer. Thus, a hacker would be prevented from using the manufacturing mode as back door to breach security measures applied to the user mode protocols.

In an embodiment of a method for customizing a data storage device, disabling the manufacturer mode may include one or more of the following actions: shutting down the data storage device, resetting the data storage device, temporarily disabling the manufacturer mode, permanently disabling the manufacturer mode, changing the default mode of the data storage device or imparting a command to the data storage device.

In an embodiment of a method for customizing a data storage device, the rate of uploading the data to be preloaded may be faster than the maximum rate of data transfer in the user mode.

In an embodiment of a method for customizing a data storage device, the user mode may further include a third protocol for transferring data between the device and the host. The third protocol may employ a third subset of the N externally accessible electrical contacts including the exclusive element (which is contained in the first subset but not in the second subset). There may also be at least one element that is contained in the second subset but that is not contained in the third subset.

In an embodiment of a method for customizing a data storage device, the third subset may contain exactly L elements wherein 0<L≦K<M≦N.

In an embodiment of a method for customizing a data storage device, the first protocol may be compliant to ISO 7816 standards employing K=5 electrical contacts, and the third protocol may be a compliant to SD/MMC standards with a single data line (and thus employ L=5 contacts), and the second protocol may be a custom protocol or the second protocol may be compliant with SD/MMC standards employing B data lines where B≧2.

In an embodiment of a method for customizing a data storage device, the first protocol may be a USB protocol while the second protocol may be a custom protocol or the second protocol may be a protocol compliant to SD/MMC standards employing B data lines where B≧2.

In an embodiment of a method for customizing a data storage device, the first protocol may be compliant with a published standard and the second protocol may be a custom protocol.

In an embodiment of a method for customizing a data storage device, the storage device may perform a further function, for example tracking financial information, identifying a user, identifying a subscriber to a service, providing a decryption key, or decrypting a signal.

### Terminology

The following terms are used in this application in accordance with their plain meanings, which are understood to be known to those of skill in the pertinent art(s). However, for the sake of further clarification in view of the subject matter of this application, the following explanations, elaborations and exemplifications are given as to how these terms may be used or applied herein. It is to be understood that the below explanations, elaborations and exemplifications are to be taken as exemplary or representative and are not to be taken as exclusive or limiting. Rather, the terms discussed below are to be construed as broadly as possible, consistent with their ordinary meanings and the below discussion.
Configure—Configuring a device to serve a function may be defined as supplying hardware or software necessary and sufficient for the device to serve the function.
Disable—Disabling a function of a device may be defined as placing the device into a state wherein the device cannot perform a particular function. A function may be disabled temporarily (e.g. until an action is taken (e.g. a command is given, the device is restarted, or the device is reinitiated) to re-enable the function) or permanently (e.g. such that, for the device to subsequently perform the function, it would be necessary to reconfigure the device). In some cases disabling a function may be achieved by reconfiguring the device so that the device will no longer perform the function.
Initiate—Initiating a device may be defined as performing an action necessary and sufficient to place a device into a state wherein the device can perform a particular function (e.g. implementing a certain mode). Initiation may be as simple as powering up a card to implement a default mode. Initiation may also include specifying a mode of operation or protocol (for example, by sending an initiation signal to the device).
Manufacturer—The word manufacturer may be defined broadly to include any actor who prepares an item for use before distribution to an end user. I inserted new paragraph here; what follows is not part of the definition.

In an example case of a SIM card, the card may include a chip made by a chipmaker. The chip is sent to a smart card manufacturer who builds the card and then customizes the card and pre-loads data into the card according to the specifications of a mobile network operator (MNO). The MNO then distributes the card to subscribers. In this example, the chipmaker and the smart card manufacturer may both be described as manufacturers while the subscriber may be described as a user or an end user. It is also feasible that a smart card manufacturer may send the card to an agent of the MNO who preloads the data (or additional data) to the card before distribution to customers. Then the agent of the MNO would also be considered a manufacturer of the card. Manufacturing arrangements other than the above are also possible, as would be appreciated by one of skill in the art in view of the description herein.

### BRIEF DESCRIPTION OF THE DRAWINGS

Various embodiments of a method for a multi-protocol data storage device for preloading of a datum by a manufacturer are herein described, by way of example only, with reference to the accompanying drawings, where:

FIG. 1 is a drawing of a multi-protocol SIM card data storage device, according to an embodiment, the device shown as being installed in a host device;

FIG. 2 illustrates a system for a manufacturer to preload data into a device such as that shown in FIG. 1.

FIG. 3a is a table illustrating a contact structure of a multi-protocol SIM card of a device such as that shown in FIG. 1;

FIG. 3b is a table illustrating an alternative contact structure of a multi-protocol SIM card of a device such as that shown in FIG. 1;

FIG. 4 is a table illustrating another alternative contact structure for a multi-protocol SIM card of a device such as that shown in FIG. 1, and

FIG. 5 is a flow chart illustrating a method of manufacturing a multi-protocol SIM card of a device such as that shown in FIG. 1, including preloading the SIM card with data.

### DESCRIPTION OF THE PREFERRED EMBODIMENTS

The principles and operation of a multi-protocol data storage device for preloading of a datum by a manufacturer according to various embodiments may be better understood with reference to the drawings and the accompanying description.

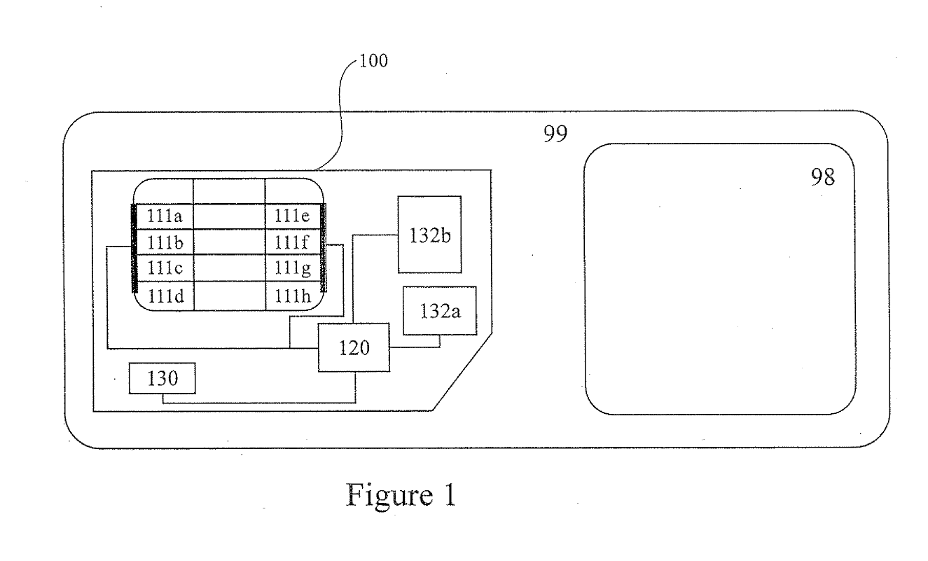

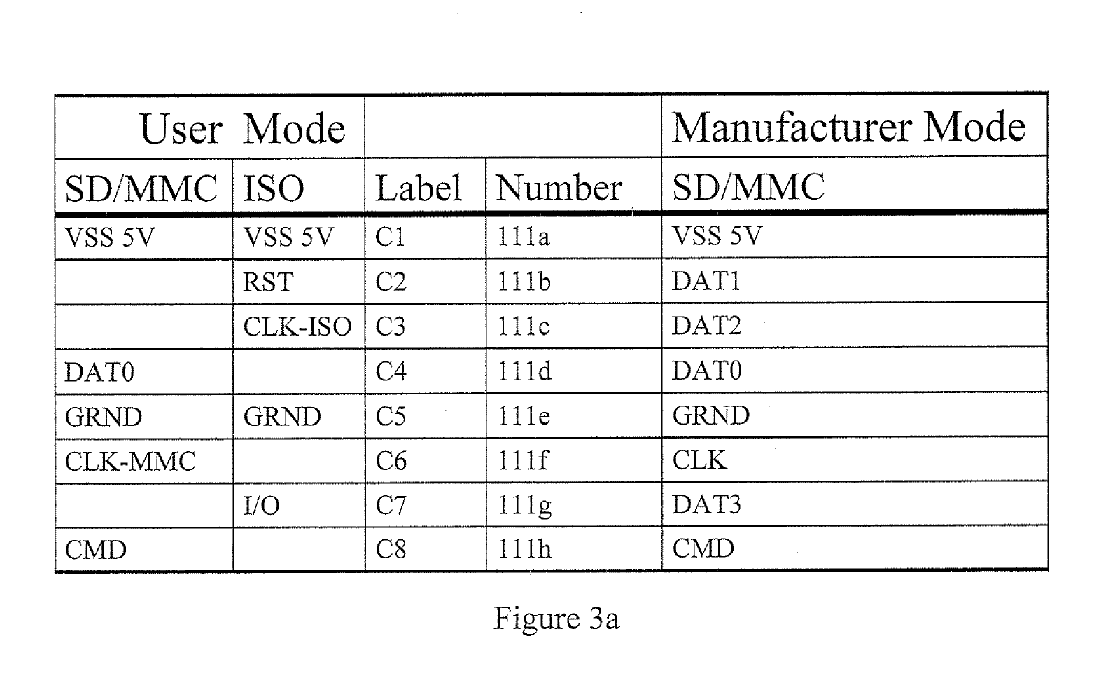

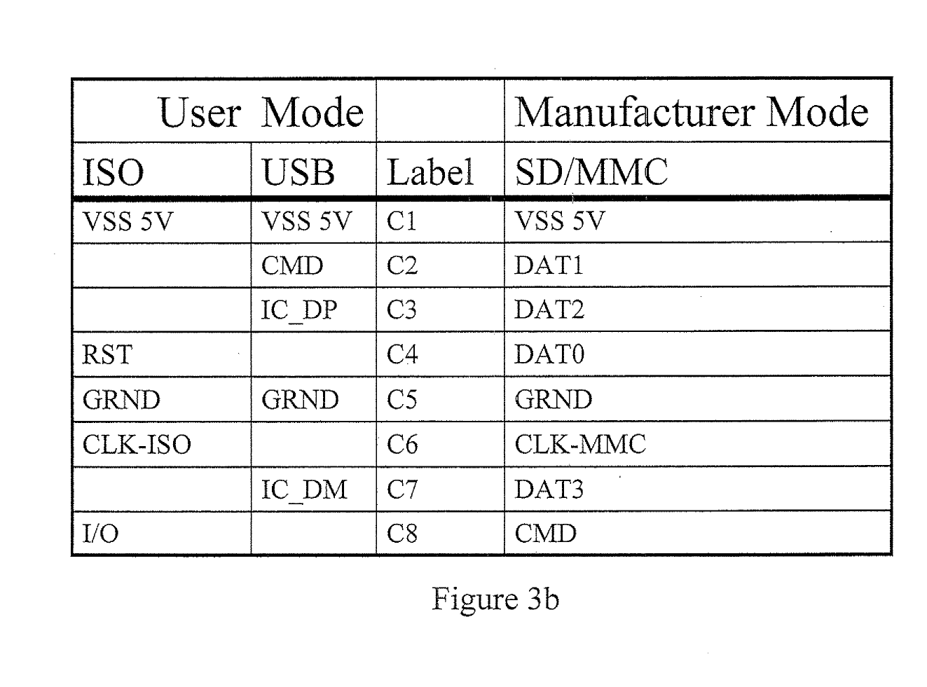

Attention is called to FIG. 1, which is a drawing of a (subscriber identification module) SIM card 100, according to an embodiment. SIM card 100 is inserted into a host 99, which is in this case a cellular (GSM) telephone having a view screen 98. (Alternatively, in the example of FIG. 1 where card 100 is a SIM card, host 99 may be a PDA, smartphone or other suitable device, as will be appreciated by one of ordinary skill in the art.) For other forms of memory devices (such as an identity card, electronic key or decoder key) the host may be a personal computer, cash register, DVB (Digital Video Broadcast) receiver or other suitable device, as will be appreciated by one of ordinary skill in the art. SIM card 100 has eight externally accessible conductive contacts 111a-h for communication and power supply. (As noted below, it is possible for a multi-protocol smartcard to have more than eight externally accessible conductive contacts.) According to ISO standards, contact C1 111a is used to supply power (VSS 5V) to the card while contact C5 111e is the ground (GRND) contact, as shown in FIG. 3a. Communication between host 99 and SIM card 100 is through a set of standard protocols that are collectively called a user mode.

The main legacy protocol used for subscriber identification is the ISO protocol, which operates according to published standard ISO 7816. Thus, the user mode of SIM card 100 includes an ISO protocol. When the proper initiation signal is received from host 99 to SIM card 100 over reset (RST) contact C2 111b, a processor 120 loads data from an integrated circuit chip 132a, which contains instructions for the ISO protocol.

According to the ISO protocol, contact C2 111b is used as a reset (RST) line, contact C3 111c is used as a clock (CLK-ISO) line, and contact C7 111g is used as an input output (I/O) line for data transfer (uploading or downloading) (see FIG. 3a).

Host 99 uses the ISO protocol to communicate with SIM card 100 for supplying user identification information to a mobile network. Therefore, when host 99 is using the legacy ISO protocol, it is desirable that access to the ISO protocol (including contacts C2 111b, C3 111c and C7 111g) not be interrupted (interruption may occur for example if the ISO pins are assigned (even temporarily) to an alternative protocol during the user mode). In the ISO protocol, data is transferred between SIM card 100 and host 99 synchronously using I/O contact C7 111g with timing signals transmitted through CLK-ISO contact C3 111c.

During user mode, while contacts C2 111b, C3 111c and C7 111g are being used for the ISO protocol a single data line SD/MMC protocol can also be run for data transfer. When the signal (for example, a proprietary command) to start the SD/MMC protocol is transferred from host 99 to processor 120, processor 120 loads data from an integrated circuit chip 132b, which contains instructions for the SD/MMC protocol. For the sake of the one line SD/MMC protocol, a clock signal (CLK-MMC) is communicated through contact C6 111f, a command (CMD) line through contact C8 111h and a single data line (DAT0) through contact C4 111d. Thus, the one data line SD/MMC protocol leaves contacts C2 111b, C3 111c and C7 111g free for subscriber identification information transfers using the ISO protocol. Because the ISO protocol leaves only three free contacts (since two of the eight contacts are taken for power and ground), in the embodiment of FIG. 1, a protocol requiring more than three communication lines cannot be run simultaneously with the ISO protocol and cannot be run in the user mode on a legacy device such as host 99.

Processor 120 is also connected to a non-volatile memory 130, which serves for storing data and for storing applications for execution by processor 120 and also by host 99. SIM card 100 may be a new generation SIM card with significant internal memory. Particularly non-volatile memory 130 may include, e.g., 500 Mbytes of data space.

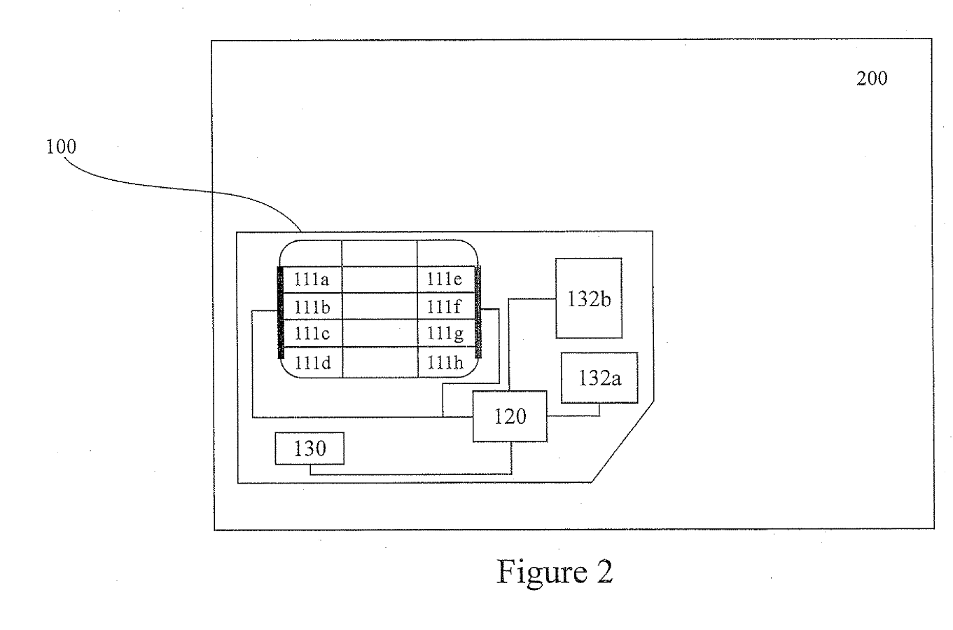

Attention is now directed to FIG. 2. In FIG. 2 SIM card 100 is shown as being attached to a manufacturer device 200. In the example of FIG. 2, manufacturer device 200 is, e.g., a computer based production machine, manufacturing station or the like with an interface (not shown) for writing to a SIM card. Before SIM card 100 is distributed to a user (e.g. a subscriber to a cellular network), a manufacturer (As discussed above, many manufacturers may be involved in producing a card. For example, a chipmaker, a smart card manufacturer and an agent of a MNO who customizes a card may each be deemed to fall under the rubric of a manufacturer. It will be understood by one of skill in the art that other entities may be involved in parts of the production process and would also fall under the rubric of a manufacturer. It will also be understood by one of skill in the art that one entity may perform multiple functions (for example, a single entity may make the chip, manufacture and customize the card, and also load customized data for the MNO)), e.g. an agent of the MNO, preloads SIM card 100 with data. Subsequently, the MNO, for example, distributes SIM card 100 to a subscriber. Device 200 is used to upload the data and software that is to be preloaded from manufacturer device 200 onto SIM card 100 (and particularly into non-volatile memory 130 of SIM card 100). For example the preloaded content may include network settings, games or audio-visual content, and advanced software for handling audiovisual content, and/or the like, according to the intended use or the requirements of the card distributor (in particular, the data to be uploaded may be specified by the MNO).

Because the manufacturer loads large quantities of data onto a large number of SIM cards, the manufacturer is interested in a high-speed mechanism to upload the data quickly onto the card, thereby saving time and money for the manufacturer. To increase the data transfer rate, SIM card 100 is configured to be employed in a manufacturer mode for data transfer. In the manufacturer mode, the ISO protocol is temporarily disabled and the three ISO contacts (C2 111b, C3 111c, and C7 111g) are used as parallel data lines for the SD/MMC protocol (in addition to the single data line (DAT0) through contact C4 111d, thus giving four data lines for SD/MMC transfer), thereby allowing a data transfer rate of four times the data transfer rate of the user mode. When the proper initiation signal is received from host 99 to SIM card 100, processor 120 loads data from second integrated circuit chip 132b, which contains instructions for the SD/MMC protocol.

Alternatively, the manufacturer mode may include a custom protocol for high-speed data upload. For example, a custom protocol may be a protocol similar to a USB protocol except that it uses multiple data lines. Alternatively, a custom protocol may be a similar to a high speed USB protocol but also having all extra contact for an external clock or other suitable protocol, as will be appreciated by one of ordinary skill in the art in view of this description. For example a custom protocol based on high speed USB with an external clock may use 6 contacts, and a USB protocol with an extra set of differential data lines may use 7 contacts. Alternatively, a custom protocol may include multiple differential data lines and also an external clock and employ 8 contacts. As will be understood by one familiar with the art, other alternative custom protocols are possible. Alternative embodiments may include more than 8 contacts and thus employ more than four contacts for data lines. It will be understood that such a custom protocol would not be accessible to a user who makes use of a standard host device.

FIG. 3a illustrates the allocation of contacts for the user mode and manufacturer mode of SIM card 100, according to one embodiment. In both modes the power source is 5V supplied on contact C1 111a and ground is supplied on contact C5 111e.

When SIM card 100 is operating in user mode, the ISO and the single data line SD/MMC protocols are both active. Alternatively, according to SIM standards the user mode may include a USB protocol and an ISO compatible protocol, i.e., an ISO protocol may be implemented over USB (implementing the USB ICCD class). In the embodiment of FIG. 3a, the ISO protocol uses contact C2 111b for restart (RST), contact C3 111c for clock (CLK-ISO), and contact C7 111g for data input/output (I/O). Simultaneously, the one data line SD/MMC protocol uses contact C4 111d (DAT0) for data transfer, contact C6 111f for clock signals (CLK-MMC) and contact C8 111h for a command line (CMD).

In the embodiment of FIG. 3a, when SIM card 100 is operating in manufacturer mode, all of the contacts are assigned to the four data line SD/MMC protocol. Particularly, the four data line SD/MMC protocol uses contact C4 111d (DAT0) for data transfer, contact C6 111f for clock signals (CLK-MMC) and contact C8 111h for a command line (CMD), as in the user mode but, in contrast to the user mode, in the manufacturer mode, the SD/MMC protocol also employs contacts C2 111b, C3 111c and C7 111g for parallel data lines DAT1, DAT2 and DAT3, thereby allowing data transfer at four times the rate of the user mode assuming the same clock rate.

In the embodiment of FIG. 3a, the ISO protocol is called the first (user mode) protocol, the multi data line SD/MMC protocol is called the second (manufacturing mode) protocol, and the one data line SD/MMC protocol is called the third (user mode) protocol. Contacts C2 111b, C3 111c and C7 111g are common to both the ISO (first, user mode) protocol and the multi data line SD/MMC (second, manufacturer mode) protocol but are not employed by the single data line SD/MMC (third, user mode) protocol. Contacts C4 111d, C6 111f and C8 111h are employed exclusively by the second (manufacturer mode multi data line SD/MMC) and third (user mode single data line SD/MMC) protocols. Contacts C1 111a and C5 111e are used commonly by all protocols. Thus the one data line SD/MMC protocol uses five contacts C1, C4, C5, C6 and C8 (111a,d,e,f,h) and the ISO protocol uses five contacts C1, C2, C3, C5 and C7 (111a,b,c,e,g), while the four line SD/MMC protocol uses all eight contacts C1-C8, 111a-h.

FIG. 3b illustrates an alternative allocation of contacts of an eight contact SIM card. In the embodiment of FIG. 3b, a USB protocol is used to transfer subscriber identification information in the user mode. The USB protocol requires a single contact for a command line and two pins for differential data transfer but does not require an external clock. Thus in the embodiment of FIG. 3b the USB protocol is called the first (user mode) protocol.

The USB protocol employs five contacts (three contacts C2 CMD, C3 IC_DP and C7 IC_DM for data and two contacts C1 VSS 5V and C5 GRND for power and ground). In an eight contact card this leaves only three free data contacts. Current standards require that for compatibility with certain legacy devices (e.g. handsets that don't support the USB protocol) these three contacts be reserved for the ISO protocol (for example C4 RST, C6 CLK-ISO and C8 I/O). Thus, in the embodiment of FIG. 3b, the ISO protocol is called the third (user mode) protocol. Thus, when the eight contact SIM card of FIG. 3b is in use with a host (in the user mode), transferring data must be according to the ISO or USB protocol. On a SIM card that lacks a high speed internal clock and crystal oscillator this limits a maximum data transfer rate in the user mode to approximately 1 Mbyte/s. Faster data uploading can be achieved if more than three data contacts are used for parallel data transfer (for example multi data line SD/MMC as described above). Therefore to achieve high-speed data communication the SIM card can be programmed to operate in a manufacturer mode in which the ISO and USB protocols are temporarily disabled and all of the available contacts are assigned to a fast protocol (multi data line SD/MMC or a custom protocol as described above).

Alternatively, for a card (not a current standard SIM card) having more than eight externally accessible contacts the manufacturer mode could use the extra contacts for even more parallel data lines resulting in a higher data-uploading rate.

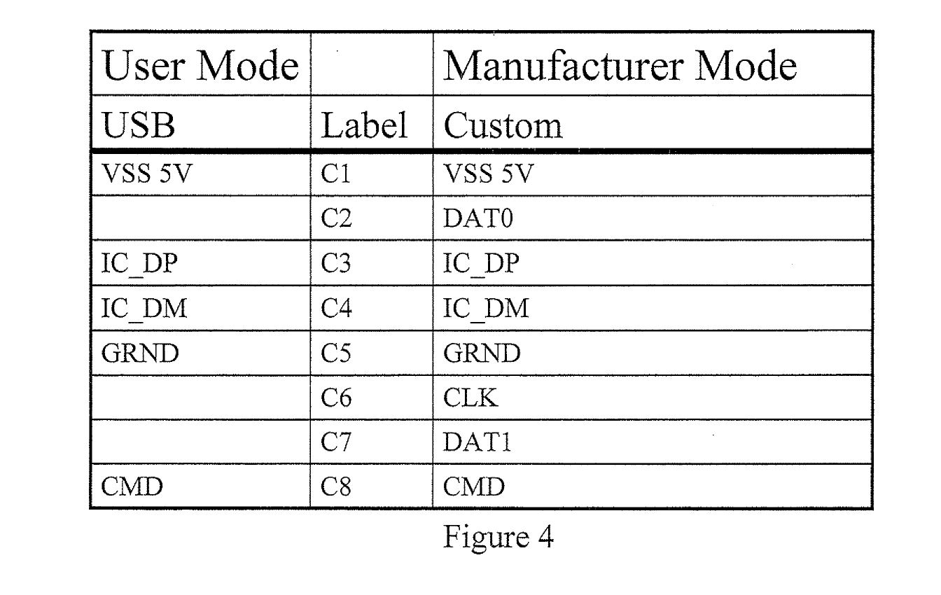

Attention is now called to FIG. 4, which illustrates the allocation of contacts for the user mode and manufacturer mode of an alternative embodiment of a multimode SIM card. The user mode of the SIM card of the embodiment of FIG. 4 includes a USB (first) protocol according to published standards and employs contact C1 for power (VSS), contact C3 for a first differential data line (IC_DP), contact C4 for a second differential data line (IC_DM), contact C5 for ground (GRND), and contact C8 for a command line (CMD). Contacts C2, C6 and C7 are idle in the user mode.

In the manufacturer mode, the SIM card of the embodiment of FIG. 4 employs a custom (second) protocol for higher rate data uploading. It should be noted that according to USB protocol standards there are a maximum of two data pins. High speed USB uses the same two data pins and a faster (non-synchronous) clock, but this requires an expensive crystal oscillator on the memory card and is considered uneconomical for SIM cards. Thus rather than using a standard high speed USB protocol, the manufacturer utilizes high speed custom (second) protocol by adding two parallel data lines (employing contacts C2 and C7 for DAT0 and DAT1 lines, respectively) to the slow USB protocol, thereby doubling the upload speed. Alternatively or additionally an external clock using contact C6 as a clock (CLK) contact can be added to the custom (second, manufacturer mode) protocol allowing the card to use synchronous communication at a rate determined by a high-speed clock of the host device.

Thus in the embodiment of FIG. 4, contacts C1, C3, C4, C5 and C8 are common contacts used by both the first, user mode protocol and the second, manufacturer mode protocol, while contacts C2, C6 and C7 are exclusive contacts used only by the second, manufacturer mode protocol.

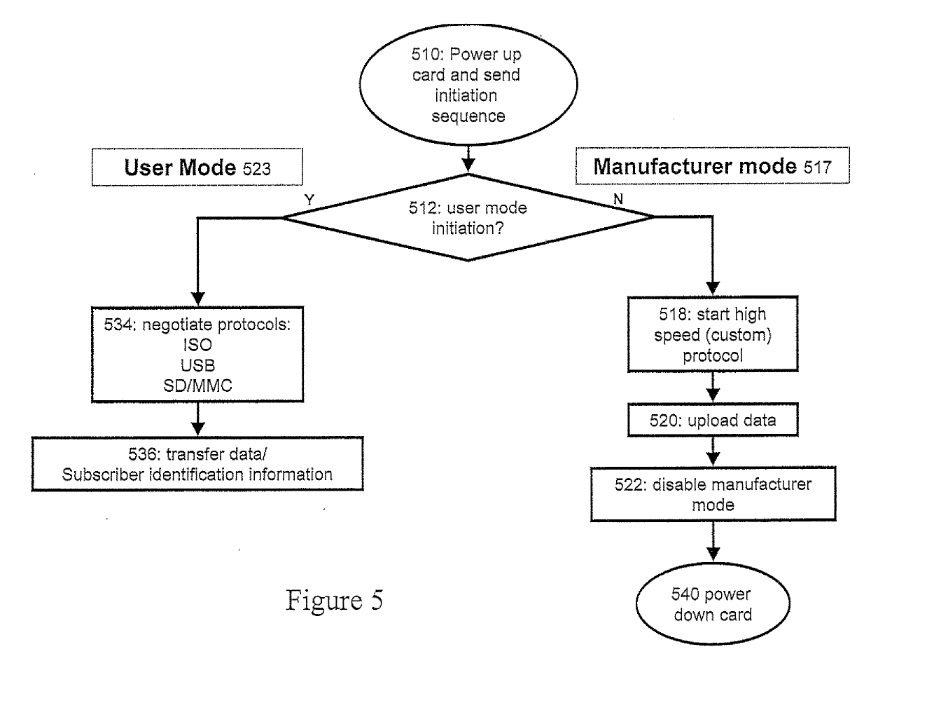

FIG. 5 is a flow chart illustrating an example method of the operation of a multi-protocol data storage device (e.g., a multi-protocol SIM card). The multi-protocol data storage device has two modes of operation, a manufacturer mode 517 and a user mode 523. At step 510, the device is powered up and an initiation signal is sent to the device. Then, at step 512, operation proceeds according to one or the other of the two modes depending on what kind of initiation signal has been sent, i.e., a user-mode initiation signal (“Y”) or not (“N”). An example of a user-mode initiation signal is a standard initiation signal, e.g., compliant with accepted standards for a single mode SIM card, while an example of a non-user-mode signal is a proprietary initiation signal.

If at step 512, the initiation signal is not a user mode initiation signal, the device enters manufacturer mode 517. When the device enters manufacturer mode 517 the device starts 518 a high-speed (e.g. custom) protocol.

In an alternative embodiment, the device may be configured to enter a standard protocol negotiation sequence upon power up 510. In such a case, specifying, during the negotiation, a protocol included in user mode 523 (e.g. a standard ISO or USB protocol) would be defined as sending a user mode initiation signal (“Y” in step 512), whereas, specifying, during the negotiation, a protocol not included in user mode 523 (e.g. a multi-data-pin SD/MMC protocol or custom protocol) would be defined as sending a non-user-mode initiation signal (“N” in step 512).

In another alternative embodiment the default mode of the data storage device may be set to manufacturing mode during fabrication of the device. In such a case, powering up 510 the device initiates the device into manufacturing mode 517, and steps 510 and 512 may be deemed to be conflated into a single step. Also, in such a case, at the end of manufacture, the manufacturer mode may be disabled by changing the default mode to user mode 523.

Subsequent to step 518, at step 520, preloaded data is uploaded to the device. After all of the preloaded data is uploaded, at step 522 the manufacturer disables manufacturer mode 517. Disabling 522 manufacturer mode 517 may be temporary or permanent and disabling 522 manufacturer mode 517 may be performed in any of a variety of ways. For example, temporarily disabling 522 manufacturer mode 517 may be effected by (the manufacturer) shutting down the data storage device (in this case, steps 522 and 540 may be deemed to be conflated into a single step). Alternatively, temporarily disabling 522 may consist of resetting the device so that the device must be reinitiated in order to operate in manufacturer mode 517. In the case where the data storage device was set during fabrication to default into manufacturing mode upon power up, then the disabling 522 may consist of (the manufacturer) changing the default mode of the device to user mode 523. In the embodiment of FIG. 5, where the mode of the device can be specified by a command upon initiation, changing the default mode of the device to user mode 523 would be deemed as temporarily disabling manufacturer mode 517. In an alternative embodiment, after changing the default mode to user mode 523, it would then be necessary to reconfigure the device in order to operate the device in manufacturer mode 517. In such a case, changing the default mode of the device to user mode 523 would be deemed as permanently disabling the manufacturer mode. As for the general case of permanently disabling manufacturer mode 517, by permanently disabling manufacturer mode 517 the device subsequently performs only in user mode 523, as if it had no manufacturer mode 517. Furthermore, permanently disabling manufacturer mode 517 prevents an unauthorized user from using manufacturer mode 517 as a “back door” for unauthorized accessing of the device. In an alternative embodiment the data storage device may be configured so that upon receiving a proprietary command, manufacture mode 517 is disabled (either permanently or temporarily). In such an embodiment disabling 522 may include imparting a command to the storage device at the end of customization.

Subsequent to step 522 the device is powered down 540. In the example of FIG. 5, powering down 540 is the last step in customizing, and hence in manufacturing, the device. Thus, in the example of FIG. 5 after powering down 540 the finished device is distributed to a user who will use the device in a host device.

If at step 512 the initiation signal is a user-mode initiation signal, then the device enters user mode 523. In user mode 523 one or more protocols are activated 534 (for example, slow USB, ISO or one data line SD/MMC). Then the host device may transfer 536 data and subscriber information to or from the data storage device.

In sum, although various example embodiments have been described in considerable detail, variations and modifications thereof and other embodiments are possible. Therefore, the spirit and scope of the appended claims is not limited to the description of the embodiments contained herein.

What is claimed is:

1. A method of customizing a data storage device having N externally accessible electrical contacts comprising:
a) providing a user mode for transferring data between the data storage device and a host, said user mode including a first protocol employing a first subset containing K contacts of the N externally accessible electrical contacts for said transferring,
b) initiating the data storage device to operate in a manufacturer mode including a second protocol employing a second subset containing M contacts of the N externally accessible electrical contacts, said second subset containing at least one common element contained in both said first subset and said second subset, and said second subset also containing at least one exclusive element not contained in said first subset, and
c) uploading a datum, by a manufacturer, to the data storage device, using said manufacturer mode.

2. The method of claim 1, further comprising:
c) disabling said manufacturer mode after said uploading.

3. The method of claim 2, wherein said disabling said manufacturer mode includes at least one action selected from the group consisting of shutting down the data storage device, resetting the data storage device, changing a default mode of the data storage device and imparting a command to the data storage device.

4. The method of claim 1, wherein said manufacturer mode is not accessible for use by an end user.

5. The method of claim 1, wherein said uploading is at a rate faster than a maximum data transfer rate of said user mode.

6. The method of claim 1, wherein said user mode further includes a third protocol for said transferring, said third protocol employing a third subset of the N externally accessible electrical contacts, said third subset containing said at least one exclusive element and wherein at least one element of said second subset is not contained in said third subset.

7. The method of claim 6, wherein said third subset contains exactly L elements and where 0<L≦K<M≦N.

8. The method of claim 7, wherein said first protocol is ISO 7816 and K=5, said third protocol is single data line SD/MMC and L=5, and said second protocol is selected from the group consisting of a custom protocol and SD/MMC with B data lines where B≧2.

9. The method of claim 1, wherein said first protocol is a USB protocol and said second protocol is selected from the group consisting of a custom protocol and SD/MMC employing B data lines where B≧2.

10. The method of claim 1, wherein said first protocol is a standard published protocol and said second protocol is a custom protocol.

11. The method of claim 1, further comprising:
d) performing at least one function selected from the group consisting of tracking financial information, identifying a user, identifying a subscriber to a service, providing a decryption key, and decrypting a signal.
